(19) United States
(12) Patent Application Publication
(10) Pub. No.: US 2002/0192066 A1
(43) Pub. Date: Dec. 19, 2002

(54) Device to contain and present flat cardboard blanks for the purpose of individual collection of the latter

(75) Inventor: Mario Gambetti, Castelfranco Emilia (IT)

Correspondence Address: THE FIRM OF KARL F ROSS, 5676 RIVERDALE AVENUE, PO BOX 900, RIVERDALE (BRONX), NY, 10471-0900, US

(73) Assignee: BAUMER S.r.l.

(21) Appl. No.: 10/154,652

(22) Filed: May 23, 2002

(30) Foreign Application Priority Data
Jun. 13, 2001 (IT) B02001A000373

(51) Int. Cl. B65G 43/10

(52) U.S. Cl. 414/798.5; 414/798.6

(57) ABSTRACT

A device (1) to contain and present flat cardboard blanks (40) for the purpose of individual collection of the lafter and comprising a first portion (10), including conveyor means (11) with a conveyor belt (12), a second portion (20), sensor means (23a, 23b) and a collection mouth (30). Downstream from the said conveyor means (11) there are provided at the top one or more thrust wheels (27a, 27b, 27c, 27d) which are designed to rotate relative to an axis (26x) which is disposed parallel to the downstream end edge of the said conveyor means (11), wherein the portion which faces upstream of the said thrust wheels (27a, 27b, 27c, 27d) interferes with the cardboard blanks (40) which are advancing, in order to apply thrust downwards for the cardboard blank (40) further downstream after rotation of the said wheels (27a, 27b, 27c, 27d).

### DESCRIPTION

The present invention relates to a device to contain and present flat cardboard blanks for the purpose of individual collection of the latter, which is particularly suitable for wrapping and/or packaging machines, wherein the flat cardboard blanks are gradually collected in individual succession in the vicinity of the downstream end of the said device by means of rotary or reciprocal collections means, and are then introduced onto the packaging line for the successive operations.

At present, see for example U.S. Pat. Nos. 5,118,249 and 3,655,072, various devices are known which are suitable for containing and separating flat cardboard blanks which have small dimensions.

The object of the present invention is a different device to contain and separate flat cardboard blanks which have large dimensions, which, in their stacked arrangement, are subjected to heavy axial loads with consequent mutual adhesion.

The invention, which is characterised by the claims, solves the problem of creating a device to contain and present flat cardboard blanks for the purpose of individual collection of the latter and comprising: a first portion which extends longitudinally, is disposed upstream, including belt-type conveyor means, in order to contain a stack of cardboard blanks supported sideways and to advance the said stack of flat cardboard blanks by command in the downstream direction; a second portion, which extends longitudinally, disposed downstream relative to the said first portion, in order to receive the cardboard blanks which are obtained from the said first portion and to advance them in the downstream direction; sensor means which act in the vicinity of the said second portion in order to detect the quantity of cardboard blanks present in the second portion; a collection mouth which is disposed downstream from the said second portion in order to retain in the correct position the cardboard blank further downstream which is disposed in the said second portion for the purpose of individual collection of the latter; a programmable control unit in order to receive the information obtained from the sensor means and to activate the belt-type conveyor means, wherein the said device is characterised in that downstream from the said conveyor means one or more thrust wheels are provided at the top, in that the said thrust wheels are designed to rotate relative to an axis which is disposed parallel to the downstream end edge of the said conveyor means, in that the portion which faces upstream of the said thrust wheels interferes with the cardboard blanks which are advancing in order to obtain thrust downwards for the cardboard blanks further downstream after rotation of the said wheels, and in that the said thrust wheels are rotated in phase ratio with the activation of the conveyor means by means of the said programmable control unit.

The results and advantages which are obtained by means of the present invention consist mainly in the fact that the cardboard blanks are regularly individually separated and in that it is possible to operate correctly even with cardboard blanks which have large dimensions and at high operative speeds.

Further characteristics and advantages of the present invention will become more apparent from the following description of a preferred practical embodiment provided purely by way of non-limiting example, with reference to the figures in the attached drawings, in which:

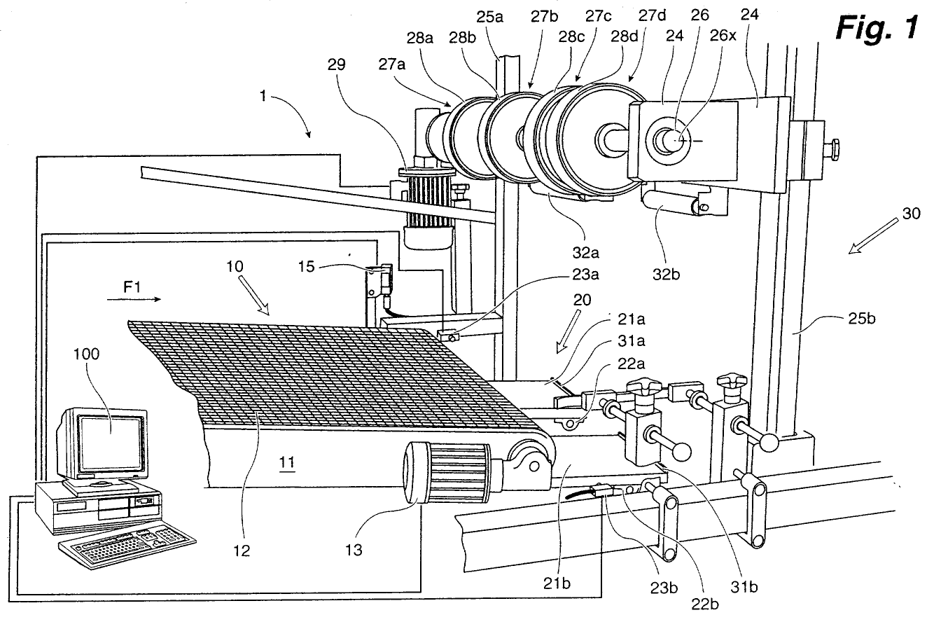

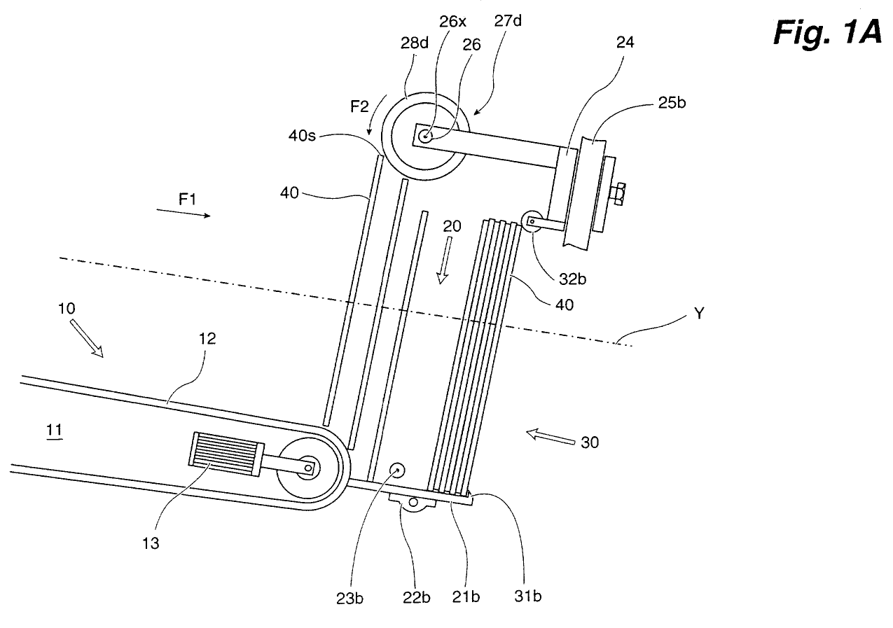

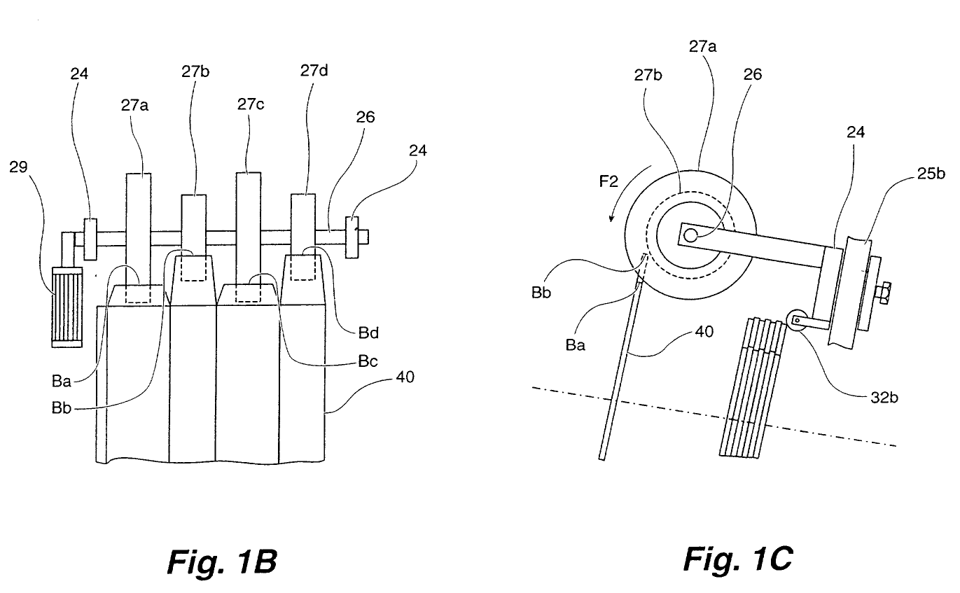

FIG. 1 is a schematic perspective view of the device which is the subject of the present invention;

FIG. 1A is a lateral schematic view of the device in FIG. 1;

FIGS. 1B and 1C are respectively a rear schematic view and a lateral schematic view illustrating a particular technical-functional aspect; and

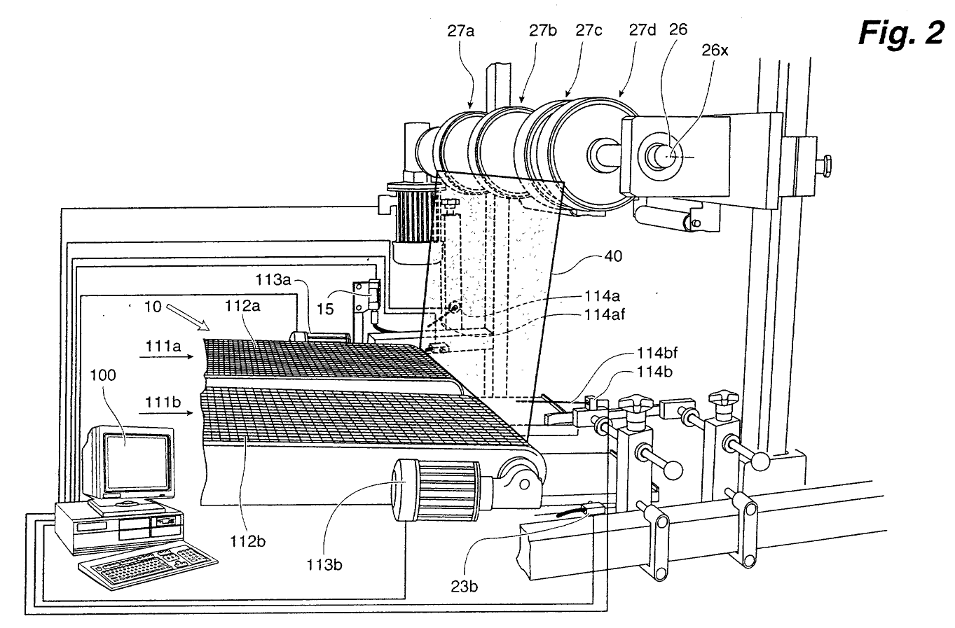

FIG. 2 is a schematic perspective view of the device which is the subject of the present invention according to a variant embodiment.

With reference to FIGS. 1 and IA, the device 1 which is the subject of the present invention extends longitudinally along an axis Y, and from upstream in the downstream direction relative to the direction F1 of advance of the cardboard blanks 40, comprises a first portion 10, downstream from which there is disposed a second portion 20, wherein the latter ends in a collection mouth 30.

The first portion 10 comprises a conveyor 11 with a conveyor belt 12 which is oriented longitudinally, defining a curved return path downstream which can be activated by means of a servomotor 13 which is connected to a programmable control unit 100, wherein the said conveyor 11 has its own transport plane inclined from upstream in the downstream direction from top to bottom, and designed to support and contain a plurality of cardboard blanks 40 which are in stacked form and are supported sideways, the quantity of which is detected by means of a sensor-transducer 15 which is also connected to the programmable control unit 100.

The second portion 20 has at the base a sliding plane 21a-21b comprising two separate planes 21a and 21b which are inclined from upstream in the downstream direction from top to bottom, which are disposed at a lower level than the downstream end edge of the conveyor 11.

The planes 21a and 21b are designed to support stacked sideways a small quantity of cardboard blanks 40 supplied from the first portion 10, wherein the said inclined planes 21a and 21b are made to vibrate by means of a corresponding vibrator 22a and 22b.

Again, the second portion 20, at a level which is slightly higher than the planes 21a and 21b, has a sensor-transducer 23a-23b, which is connected to the control unit 100 and is designed to detect the quantity of cardboard blanks 40 disposed on the said support planes 21a and 21b, and at the top has a frame 24 which extends transversely, can be positioned vertically by means of two piers 25a and 25b of the machine frame, and is designed to support in a rotary manner a shaft 26, the axis 26x of which is disposed parallel to the downstream end edge of the conveyor 11, wherein the said shaft 26 supports keyed onto it a plurality of thrust wheels 27a, 27b, 27c, 27d, each of which is provided with a circumferential cover 28a, 28b, 28c, 28d made of material which is deformable and/or has a high coefficient of friction, such as rubber or polyurethane, and wherein the said shaft 26 is rotated by means of a servomotor 29 which is also connected to the said programmable control unit 100.

The thrust wheels 27a, 27b, 27c, 27d, see in particular the wheel 27d in FIG. 1A, are preferably positioned vertically at a height such that their lower branch which faces upstream meets the upper edge 40s of the cardboard blanks which are advancing disposed on the conveyor 11, in order, when they are rotated in the direction F2 as described in greater detail hereinafter, to obtain a force directed from the top downwards by acting on the upper edge 40s of the cardboard blanks 40 disposed further downstream, but, if required and/or preferred, the said wheels 27a, 27b, 27c, 27d can also be positioned at a lower level, in order to obtain a similar force directed from the top downwards obtained by friction on the outer surface of the cardboard blank 40 further downstream.

With particular reference to the embodiment illustrated in FIGS. 1B and 1C, in the case in which the cardboard blanks 40 have an upper edge with upper segments Ba, Bb, Bc, Bd with different heights, thrust wheels 27a, 27b, 27c, 27d with different outer diameters are disposed on the shaft 26, in order to obtain a stop profile for the said thrust wheels 27a, 27b, 27c, 27d which is designed to contact the upper segments Ba, Bb, Bc, Bd disposed at different heights.

At its base the collection mouth 30 comprises a plurality of stop teeth 31a and 31b and at its top it comprises two stop rollers 32a and 32b, the lafter being supported by the frame 24 which can be positioned vertically.

With this structuring, when the sensor-transducer 23a-23b communicates to the control unit 100 that the presence of cardboard blanks 40 in the second portion 20, i.e. on the vibrating planes 21a, 21b, is low, the said control unit 100 activates the servomotor 13 and the servomotor 29, with consequent advance in the downstream direction of the stack of cardboard blanks 40 disposed on the conveyor belt 12.

During the said advance, see in particular FIG. 1A, the cardboard blanks 40 which are being translated by the conveyor 12 to the vibrating planes 21a and 21b, following with their lower edge the curved return path of the conveyor 12, owing to the axial thrust downwards generated by the thrust wheels 27a, 27b, 27c, 27d, are gradually forced to separate individually in relation to the remainder of the stack which is facing upstream, thus anticipating the fall of the cardboard blanks and therefore solving the above-described problems relating to the separation of the cardboard blanks.

The said cardboard blanks 40, thus individually separated, fall onto the inclined vibrating planes 21a-21b, and then advance by jumping, i.e. without adhering to one another, in the downstream direction, until they meet the teeth 31a, 31b at the base and the rollers 32a and 32b at the top, thus becoming correctly aligned for collection.

### Variant Embodiment

FIG. 2 illustrates a variant embodiment of the above-described device 1 wherein, more particularly, in the first portion 10, the conveyor means comprise a first conveyor 111a with a conveyor belt 112a which extends longitudinally along a first longitudinal side and a second conveyor 111b with a conveyor belt 112b which extends longitudinally, disposed along a second longitudinal side, which conveyors are spaced transversely from one another, and on which the cardboard blanks 40 will be disposed stacked and supported sideways.

The first conveyor 111a is activated by means of a respective servomotor 113a connected to the programmable control unit 100, and similarly the second conveyor 111b is activated by means of a respective second servomotor 113b, which is also connected to the programmable control unit 100 in order to be able to activate and/or stop and/or control the said two conveyors 111a and 111b independently.

On the first side of the equipment 1 itself there is provided a third sensor-transducer 114a, a (proximity) distance measurer, such as an ultrasound or optoelectronic or other type of transducer, connected to the programmable control unit 100, which is designed to detect the position of longitudinal advance along the first conveyor 111a of the lower part of the cardboad blank 40 disposed further downstream, for example by means of a beam 114af, and similarly on the second side of the device itself there is provided a fourth sensor-transducer 114b, which is connected to the programmable control unit 100, designed to detect the position of longitudinal advance along the second conveyor 111b of the lower part of the cardboard blank disposed further downstream, for example by means of a beam 114bf.

By means of this structuring, when the sensor-transducer 23a-23b communicates to the control unit 100 that the presence of cardboard blanks 40 in the second portion 20, i.e. on the vibrating planes 21a and 21b, is low, the control unit 100 activates the servomotors 113a and 113b and the servomotor 29, with consequent advance of the stack of cardboard blanks 40 disposed on the conveyor belts 112a and 112b in the downstream direction, wherein, during this step, the sensors 114a and 114b gradually detect the position on the two transversely opposite sides of the cardboard blanks 40 disposed further downstream, communicate the data detected to the programmable control unit 100, which controls the two servomotors 113a and 113b independently, in order to advance the said stack whilst maintaining the lower portion of the cardboard blanks 40 parallel relative to the curved return downstream end edge of the conveyors 111a and 111b, thus obtaining correct separation and correct translation of the cardboard blanks 40 from the first portion 10 to the second portion 20, therefore eliminating jamming and/or malfunctioning caused by the assumption of incorrect orientations.

More particularly, for example, if the sensors 114a and 114b detect that the lower portion of a cardboard blank 40 on the side of the conveyor 111a is further advanced than the portion disposed on the side of the conveyor 111b, on the basis of a pre-recorded programme the said control unit 100 delays the advance of the conveyor 111a in comparison with the conveyor 111b, or accelerates the advance of the conveyor 111b in comparison with the conveyor 111a, or stops the conveyor 111a until the correct arrangement is obtained for the cardboard blank 40.

The description of the device to contain and present flat cardboard blank products for the purpose of individual collection of the latter, and of the variant embodiment of the device, are provided purely by way of non-limiting example, and thus, all modifications and variations suggested by practice and by their utilisation or use can be made to them, within the context of the scope of the following claims.

1.) Device to contain and present flat cardboard blanks for the purpose of individual collection of the latter and comprising: a first portion (10) which extends longitudinally, is disposed upstream, including belt-type conveyor means (11; 111a, 111b), in order to contain a stack of cardboard blanks (40) supported sideways and to advance the said stack of flat cardboard blanks (40) by command in the downstream direction; a second portion (20), which extends longitudinally, disposed downstream relative to the said first portion (10), in order to receive the cardboard blanks (40) which are obtained from the said first portion (10) and to advance them in the downstream direction; sensor means (23a-23b) which act in the vicinity of the said second portion (20) in order to detect the quantity of cardboard blanks (40) present in the second portion (20); a collection mouth (30) which is disposed downstream from the said second portion (20) in order to retain in the correct position the cardboard blank (40) further downstream which is disposed in the said second portion (20) for the purpose of individual collection of the latter; a programmable control unit (100) in order to receive the information obtained from the sensor means (23a-23b) and to activate the belt-type conveyor means (11; 111a, 111b), characterised in that downstream from the said conveyor means (11; 111a, 111b) one or more thrust wheels (27a, 27b, 27c, 27d) are provided at the top, in that the said thrust wheels (27a, 27b, 27c, 27d) are designed to rotate relative to an axis (26x) which is disposed parallel to the downstream end edge of the said conveyor means (11; 111a, 111b), and in that the portion which faces upstream, of the said thrust wheels (27a, 27b, 27c, 27d) interferes with the cardboard blanks (40) which are advancing in order to obtain thrust downwards for the cardboard blanks (40) further downstream by rotation of the said wheels (27a, 27b, 27c, 27d).

2.) Device according to claim 1, characterised in that the said thrust wheels (27a, 27b, 27c, 27d) are rotated in phase ratio with the activation of the conveyor means (11; 111a, 111b) by means of the said programmable control unit (100).

3.) Device according to any one of the preceding claims claim 1, characterised in that the said thrust wheels (27a, 27b, 27c, 27d) have their lower circumference portion which faces upstream interfering with the upper edge (40s) of the cardboard blanks (40) which are advancing.

4.) Device according to any one of the preceding claims claim 1, characterised in that the said thrust wheels (27a, 27b, 27c, 27d) have outer diameters which are different from one another in order to follow the profile of the upper edges (Ba, Bb, Bc, Bd) of the cardboard blanks (40).

5.) Device according to any one of the preceding claims, characterised in that the said thrust wheels (27a, 27b, 27c, 27d) are keyed onto a shaft (26) which is supported such as to rotate by a frame (24) and in that the said frame (24) can be positioned vertically.

6.) Device according to any one of the preceding claims, characterised in that the said shaft (26) is rotated by means of a corresponding servomotor (29) and in that the said servomotor (29) is controlled by means of the programmable control unit (100).

7.) Device according to any one of the preceding claims, characterised in that the said thrust wheels (27a, 27b, 27c, 27d) have a circumferential cover (28a, 28b, 28c, 28d) made of material which is deformable and/or has a high coefficient of friction.

8.) Device according to any one of the preceding claims, characterised in that the said second portion (20) has support planes (21a, 21b) for the cardboard blanks (40) which are inclined from upstream in the downstream direction from top to bottom and in that the said inclined planes (21b, 21b) are made to vibrate (22a, 22b).

9.) Device according to any one of the preceding claims, characterised in that the said conveyor means comprise a first conveyor (111a) with a conveyor belt (112a) which extends longitudinally, disposed along a first longitudinal side of the first portion (10) and a second conveyer (111b) with a conveyor belt (112b) which extends longitudinally, disposed along a second longitudinal side of the first portion (10) itself; in that the said first conveyor (111a) is activated by means of a corresponding first servomotor (113a) connected to the programmable control unit (100); in that the said second conveyor (111b) is activated by means of a corresponding second servomotor (113b) connected to the programmable control unit (100); in that a first sensor-transducer (114a) is provided, which is connected to the programmable control unit (100) and is designed to detect the position of longitudinal advance along the first conveyor (111a) of the lower part of the cardboard blanks (40) disposed further downstream, and in that a second sensor-transducer (114b) is provided, which is connected to the programmable control unit (100) and is designed to detect the position of longitudinal advance along the second conveyor (111b) of the lower part of the cardboard blanks (40) disposed further downstream.

10.) Device to contain and present flat cardboard blanks for the purpose of individual collection of the latter and comprising: a first portion (10) which extends longitudinally, is disposed upstream, including belt-type conveyor means (111a, 111b), in order to contain a stack of cardboard blanks (40) supported sideways and to advance the said stack of flat cardboard blanks (40) by command in the downstream direction; a second portion (20), which extends longitudinally, disposed downstream relative to the said first portion (10), in order to receive the cardboard blanks (40) which are obtained from the said first portion (10) and to advance them in the downstream direction; sensor means (23a-23b) which act in the vicinity of the said second portion (20) in order to detect the quantity of cardboard blanks (40) present in the second portion (20); a collection mouth (30) which is disposed downstream from the said second portion (20) in order to retain in the correct position the cardboard blank (40) further downstream which is disposed in the said second portion (20) for the purpose of individual collection of the lafter; a programmable control unit (100) in order to receive the information obtained from the sensor means (23a-23b) and to activate the belt-type conveyor means (111a, 111b), characterised in that the said conveyor means comprise a first conveyor (111a) with a conveyor belt (112a) which extends longitudinally, disposed along a first longitudinal side of the first portion (10) and a second conveyer (111b) with a conveyor belt (112b) which extends longitudinally, disposed along a second longitudinal side of the first portion (10) itself; in that the said first conveyor (111a) is activated by means of a corresponding first servomotor (113a) connected to the programmable control unit (100); in that the said second conveyor (111b) is activated by means of a corresponding second servomotor (113b) connected to the programmable control unit (100); in that a first sensor-transducer (114a) is provided, which is connected to the programmable control unit (100) and is designed to detect the position of longitudinal advance along the first conveyor (111a) of the lower part of the cardboard blanks (40) disposed further downstream, and in that a second sensor-transducer (114b) is provided, which is connected to the programmable control unit (100) and is designed to detect the position of longitudinal advance along the second conveyor (111b) of the lower part of the cardboard blanks (40) disposed further downstream.

11.) Device according to any one of the preceding claims, characterised in that the said collection mouth (30) has in the vicinity of its upper part retention means which comprise rollers (32a, 32b).
